(19) United States
(12) Patent Application Publication
(10) Pub. No.: US 2008/0155118 A1
(43) Pub. Date: Jun. 26, 2008

(54) REALLY SIMPLE SYNDICATION (RSS) FEED CUSTOMIZATION

(75) Inventors: Howard Justin GLASER, San Jose, CA (US); David Robert DRAEGER, Rochester, MN (US)

Correspondence Address: KONRAD RAYNES & VICTOR, LLP;ATTN: IBM54, 315 SOUTH BEVERLY DRIVE, SUITE 210, BEVERLY HILLS, CA, 90212, US

(73) Assignee: INTERNATIONAL BUSINESS MACHINES CORPORATION, Armonk, NY (US)

(21) Appl. No.: 11/614,926

(22) Filed: Dec. 21, 2006

(51) Int. Cl. G06F 15/173

(52) U.S. Cl. 709/238

(57) ABSTRACT

Provided are techniques for accessing data. In response to receiving a request for data content associated with a feed location, it is determined whether the feed location has an associated unique subscriber identifier. In response to determining that the feed location does not have an associated unique subscriber identifier, a unique subscriber identifier is generated for the feed location, wherein the feed location and unique subscriber identifier comprise a user-specific feed location. User preferences are associated with the user-specific feed location. The data content is filtered based on the user preferences.

### BACKGROUND

1. Field

Embodiments of the invention relate to customization of Really Simple Syndication (RSS) feeds.

2. Description of the Related Art

RSS (Really Simple Syndication) has become a popular delivery mechanism for users to subscribe to news headlines via browsers. RSS may be described as a lightweight eXtensible Markup Language (XML) format designed for sharing headlines and other Internet content. There are various specifications and standards that further define RSS. Each RSS file contains a list of items. Each item has, for example, a title, a summary, and a link to a Uniform Resource Locator (URL). When an RSS file is updated, all external sites or user browsers that subscribe to the RSS feed are updated as well.

With RSS, a browser (e.g., Windows® Internet Explorer® 7 available from Microsoft Corporation; Microsoft, Windows, Windows NT, the Windows logo, and Internet Explorer are trademarks of Microsoft Corporation in the United States, other countries, or both) typically includes an RSS reader plug-in. A plug-in may be described as a program that interacts with a host application, such as a browser, to provide additional function. Specifically, an RSS reader plug-in may be described as storing RSS URLs selected by the user and as having an agent that periodically checks those URLs to see if they have been updated. If the RSS reader plug-in determines the RSS feeds have been updated since the last check, the RSS reader plug-in alerts the user and may grab copies of the RSS feeds to be stored locally in the browser cache. The RSS reader plug-in may also include a Graphical User Interface (GUI) in the browser that has a tree view of a user's RSS URLs, a pane showing the list of titles, and a pane displaying the contents of a title when a user selects that title (e.g., by using a mouse to point and click on the title). Subscription is selected by the user adding an RSS feed URL to an RSS reader plug-in. The RSS reader plug-in may be installed in the browser by the user or may be part of the browser functionality.

FIG. 1 illustrates a prior art graphical user interface 100. The graphical user interface 100 includes news categories of “National News”, “Health News”, and “Sports News”. Each news item is associated with an RSS icon 110, 120, 130. A user may subscribe to a particular news item by selecting an associated RSS icon 110, 120, 130. For example, to select the “Health News” news item, a user selects RSS icon 120. The “Health News” news item is then added to the Reader list of RSS URLs.

In addition, if multiple users are a proxy, such as in many corporations, the multiple users may be seen as coming from the same IP address.

There are various versions of RSS, including RSS 0.91, RSS 0.92, and RSS 2.0. With reference to RSS 0.91, there are no more than 15<items> in a 0.91<channel>. A channel may be described as another term for an actual RSS feed. In an RSS file, the channel XML tag contains metadata about the RSS feed and its contents. An item may be described as representing a “story” (e.g., such as a story in a newspaper or magazine), and the item provides a description that is a synopsis of the story, along with a link that points to the full story. An item may also be complete in itself, and, if so, the description contains the text and the link, with the title being omitted.

There are no string-length or XML-level limits in RSS version 0.92 and greater versions. Processors may impose their own limits, and generators may have preferences that say no more than a certain number of <item>s can appear in a channel, or that strings are limited in length. Generators may be described as any person or machine that creates the properly formed XML file that makes up an RSS or Atom feed.

In RSS 2.0, a provision is made for linking a channel to an associated identifier in a cataloging system, using a channel-level category feature. For example, to link a channel to its Syndic8 identifier, a category element is included as a sub-element of <channel>, with domain “Syndic8”, and the value of the identifier for channel being stored in a Syndic8 web site database. A domain may be described as a string that identifies a categorization taxonomy. Syndic8 is a reference to Syndic8.com, which is a web site that serves up links to RSS feeds. As an example, an appropriate category element for “Scripting News” is:

<category domain=“Syndic8”>1765</category>.

A programmer may include as many category elements as desired, for different domains, and may have an item cross-referenced in different parts of the same domain.

Using RSS content syndication technology for web support content (such as flashes, technotes, Authorized Program Analysis Reports (APARs), and downloads), an RSS reader plug-in automatically checks a product support RSS feed for new content on a web site and alerts the user via the browser when new content is available. Web support may be described as product web support with online documents, such as Frequently Asked Questions (FAQs), how-tos, and documents for workarounds. A technote may be described as documenting a reported customer problem and a currently available solution to that problem. The technote may include brief how-to information on installation, configuration, troubleshooting and usage, as well as answering frequently asked questions. An Authorized Program Analysis Report(APAR) may be described as a formal report of a problem caused by a suspected defect in a current unaltered release of a program. A download may be described as a software maintenance package, such as an interim fix, fix pack or Program Temporary Fix (PTF) that solves one or more product defects. A flash may be described as a news bulletin or headline about a product related technical issue. The browser is updated with a list of selected content headlines/links contained within the RSS feed file. Using this technology, it is possible to deliver support information directly to the user's workstation via RSS reader plug-ins.

Currently, RSS feeds are implemented as a fixed set of content for all users and are updated in terms of most recent content, but the content is not filtered per user. For example, if one hundred users subscribed to the “Health News” news item, each of the one hundred users would obtain the same content. Thus, current implementations of RSS feeds may be described as, essentially, a one size fits all model. In order to broaden the usefulness of this technology and use the technology in ways not currently available, a technique is needed to build customized RSS feeds.

RSS implementations initiate a request from a browser (i.e., a pull technology rather than a push technology) to access RSS feeds. Traditionally, a browser does not uniquely identify itself. While the computer's assigned Internet Protocol (IP) addresses theoretically can be used, it is usually not possible because assigned IP addresses change over a period of time due to hosts dynamically assigning IP addresses. In addition, if multiple users are behind a proxy, such as in many corporations, the multiple users may be seen as coming from the same IP address. Also, it is not practical to explicitly require the user to authenticate (e.g., by entering a user name and password) with a server computer every time the browser checks an RSS feed. To address this, a technique is needed to enable the browser to uniquely identify itself.

Thus, there is a need in the art for customization of Really Simple Syndication (RSS) feeds.

### SUMMARY OF EMBODIMENTS OF THE INVENTION

Provided are a method, computer program product, and system for accessing data. In response to receiving a request for data content associated with a feed location, it is determined whether the feed location has an associated unique subscriber identifier. In response to determining that the feed location does not have an associated unique subscriber identifier, a unique subscriber identifier is generated for the feed location, wherein the feed location and unique subscriber identifier comprise a user-specific feed location. User preferences are associated with the user-specific feed location. The data content is filtered based on the user preferences.

### BRIEF DESCRIPTION OF THE DRAWINGS

Referring now to the drawings in which like reference numbers represent corresponding parts throughout:

FIG. 1 illustrates a prior art graphical user interface.

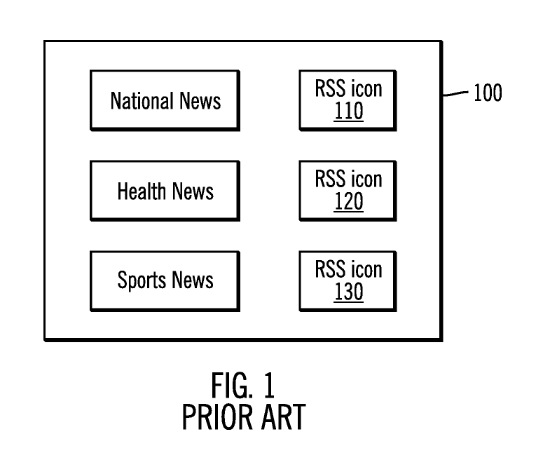

FIG. 2 illustrates details of a computing environment in accordance with certain embodiments.

FIG. 3 illustrates logic performed by an RSS reader in accordance with certain embodiments.

FIG. 4 illustrates logic performed at a server computer in accordance with certain embodiments.

FIG. 5 illustrates a sample graphical user interface in accordance with certain embodiments.

FIG. 6 illustrates logic performed by an RSS reader in response to receiving data content in accordance with certain embodiments.

FIG. 7 illustrates a system architecture that may be used in accordance with certain embodiments.

### DETAILED DESCRIPTION

In the following description, reference is made to the accompanying drawings which form a part hereof and which illustrate several embodiments of the invention. It is understood that other embodiments may be utilized and structural and operational changes may be made without departing from the scope of the invention.

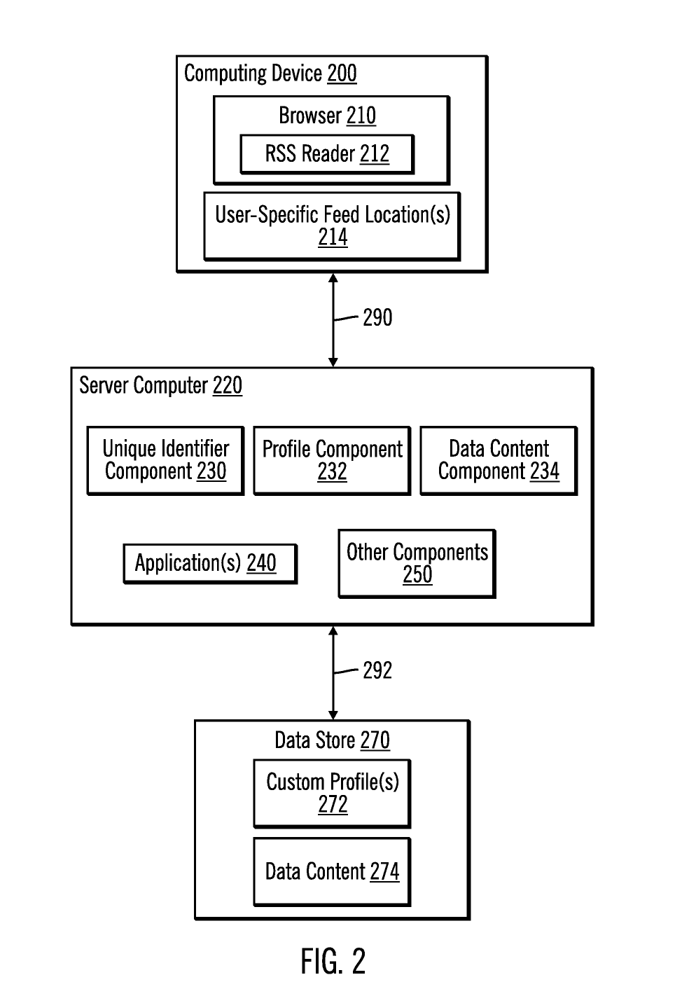

FIG. 2 illustrates details of a computing environment in accordance with certain embodiments. A computing device 200 is connected via a communication path 290 to a server computer 220. The computing device 200 includes a browser 210 and one or more user-specific feed locations 214. A user-specific feed location 214 may be described as a data location for an RSS feed that is associated with a particular user. A data location may be described as a Uniform Resource Identifier (URI) or a URL. The browser 210 includes an RSS reader 212. In certain embodiments, the RSS reader 212 is a plug-in to the browser 210. In various embodiments, the RSS reader 212 may be a standalone program with its own rendering or a program that gets the RSS feeds and passes them along to another program that does something with the RSS feeds. For example, some wikis consume an RSS feed and display the information as HTML on the wiki web page.

The server computer 220 includes a unique identifier component 230, a profile component 232, and a data content component 234. The unique identifier component 230 associates unique subscriber (or “requestor”) identifiers (also referred to as “UIDs”) with locations of RSS feeds to create the user-specific feed locations. The profile component 232 enables creation of a custom profile 272 that describes user preferences for content. The data content component 234 uses a unique subscriber identifier to filter data content 274 for an RSS feed. The data content component 234 may also be described as a file generating system using the information provided by the custom profile to generate a unique RSS XML feed. The server computer 220 also includes one or more applications 240 and may include other components 250.

Although components 230, 232, 234 are illustrated as separate components, in various embodiments, the functionality of these components 230, 232, 234 may be combined into fewer components or may be part of more components.

The server computer 220 provides the computing device 200 with access to data store 270. The server computer 220 is coupled to data store 270 via a communication path 292. The data store 270 includes one or more custom profiles 272 and data content 274. A custom profile 272 may be described as storing customized settings for a user to generate one or more RSS feeds. The data content 274 includes RSS XML feeds for web pages, menus, wikis, blogs, news feeds, or any list of information stored on the Internet including data, and messages.

The computing device 200 and server computer 220 may each comprise any computing device known in the art, such as a server, mainframe, workstation, personal computer, hand held computer, laptop telephony device, network appliance, cellular phone, etc.

The communication path 290 may comprise, for example, any type of network, such as, for example, a peer-to-peer network, spoke and hub network, Storage Area Network (SAN), a Local Area Network (LAN), Wide Area Network (WAN), the Internet, an Intranet, etc.

If the data store 270 is another server with the capabilities of storing data, such as using the IBM® DB2® database software (IBM and DB2 are registered trademarks of International Business Machines Corporation in the United States, other countries, or both), the communication path 292 may comprise, for example, any type of network, such as, for example, a peer-to-peer network, spoke and hub network, Storage Area Network (SAN), a Local Area Network (LAN), Wide Area Network (WAN), the Internet, an Intranet, etc. If the data store 270 is a storage container, such as a Redundant Array of Independent Disks (RAID) box that only contains hard drives and no processing unit to run an operating system, then the communication path 292 may comprise, for example, Universal Serial Bus (USB) cables, Small Computer System Interface (SCSI) cables, Fibre channel interface, Institute of Electrical Engineering (IEEE) 1394 (Firewire), or Integrated Drive Electronics (IDE) cables.

Embodiments provide a mechanism to generate customized RSS feeds using an authentication mechanism (i.e., a unique subscriber identifier associated with a feed location), a custom profile, a content management scheme that provides the information needed to generate a custom RSS feed XML file, and tooling (which is code in a Java® Server Page (JSP) or ActiveX® Server Page (ASP); Java and all Java-based trademarks are trademarks of Sun Microsystems, Inc. in the United States, other countries, or both; ActiveX is a trademark of Microsoft Corporation in the United States, other countries, or both) to generate customized RSS feeds.

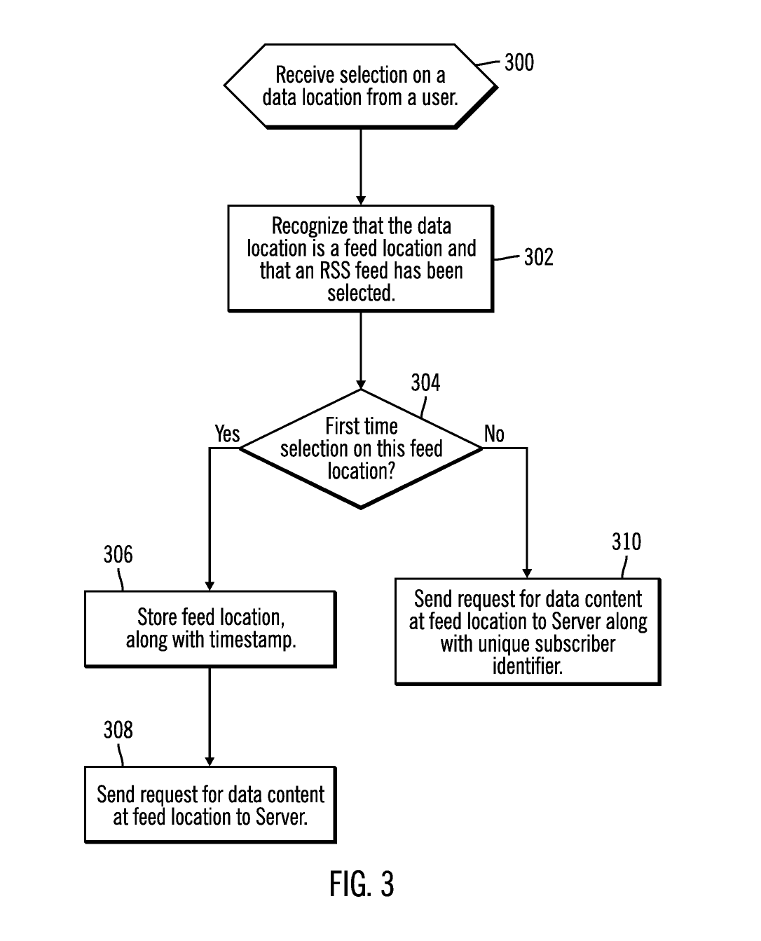

FIG. 3 illustrates logic performed by the RSS reader 212 in accordance with certain embodiments. In block 300, the RSS reader 212 receives selection of a data location from a user (e.g., selection of a “Health News” news item). In block 302, the RSS reader 212 recognizes that the data location is a feed location and that an RSS feed has been selected.

In block 304, the RSS reader 212 determines whether this is the first time the user has selected this feed location. If so, processing continues to block 306, otherwise, processing continues to block 310. In block 306, the RSS reader 212 stores a feed location, along with a timestamp, for the selected feed. In block 308, the RSS reader 212 sends a request for data content 274 at the feed location to the server computer 220. In block 310, the RSS reader 212 sends a request for data content 274 at the feed location to the server computer 220, along with a unique subscriber identifier.

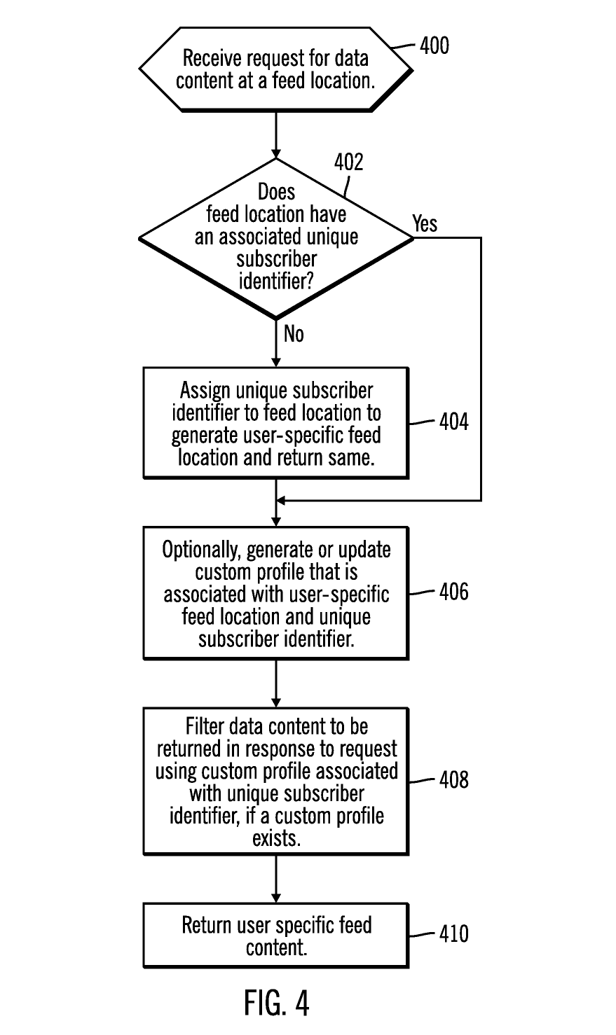

FIG. 4 illustrates logic performed at the server computer 220 in accordance with certain embodiments. Control begins at block 400 with the server computer 220 receiving a request for data content 274 at a feed location. In block 402, the unique identifier component 230 determines whether the feed location has an associated unique subscriber identifier. If so, processing continues to block 406, otherwise, processing continues to block 404. In block 404, the unique identifier component 230 assigns a unique subscriber identifier to the feed location to generate a user-specific feed location and returns the unique subscriber identifier to the RSS reader so that the RSS reader 212 is able to send subsequent requests with the user-specific feed location. Thus, the unique subscriber identifier is assigned to the feed location when a user subscribes to an RSS feed. Examples of possible URLs with unique subscriber identifiers are:

1. http://www.mydomain.com/rss/rss.xml?uid=88743

2. http://www.mydomain.com/rss/rss.xml/88743

3. http://www.mydomain.com/rss/88743/rss.xml

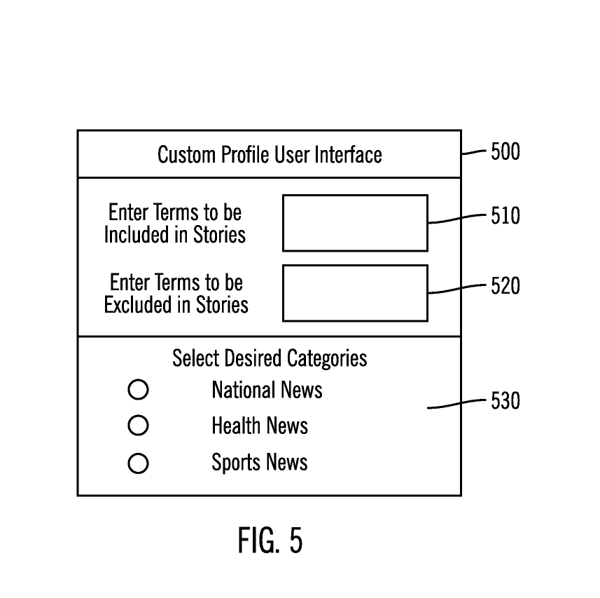

In block 406, optionally, a profile component 232 generates or updates a custom profile 272 that is associated with the user-specific feed location and with the unique subscriber identifier. In certain embodiments, the profile component 232 tracks a user's use of the browser 210 and automatically generates or updates the custom profile 272. In certain embodiments, the profile component 232 provides a graphical user interface through which a user may generate or update the custom profile 272. It is possible for users to set preferences on how to filter, sort, and order information sent to them via RSS feeds via settings in a custom profile 272 at the server computer 220. Users may also set preferences for how much information is sent to them (e.g., may set a limit of three lines of text at a time, which may be especially useful for computing devices such as cellular phones). FIG. 5 illustrates a sample graphical user interface 500 in accordance with certain embodiments. A user may enter terms to be included in stories of an RSS feed 510, may enter terms to be excluded from stores in the RSS feed 520, and/or may select desired categories 530.

Returning to FIG. 4, in block 408, the data content component 234 filters data content 274 to be returned in response to the request using a custom profile 272 associated with the unique subscriber identifier, if a custom profile 272 exists. In particular, the data content component 234 generates a custom query using the custom profile.

In block 410, the server computer 220 returns user specific feed content 274 to the RSS reader 212 at the computing device 200.

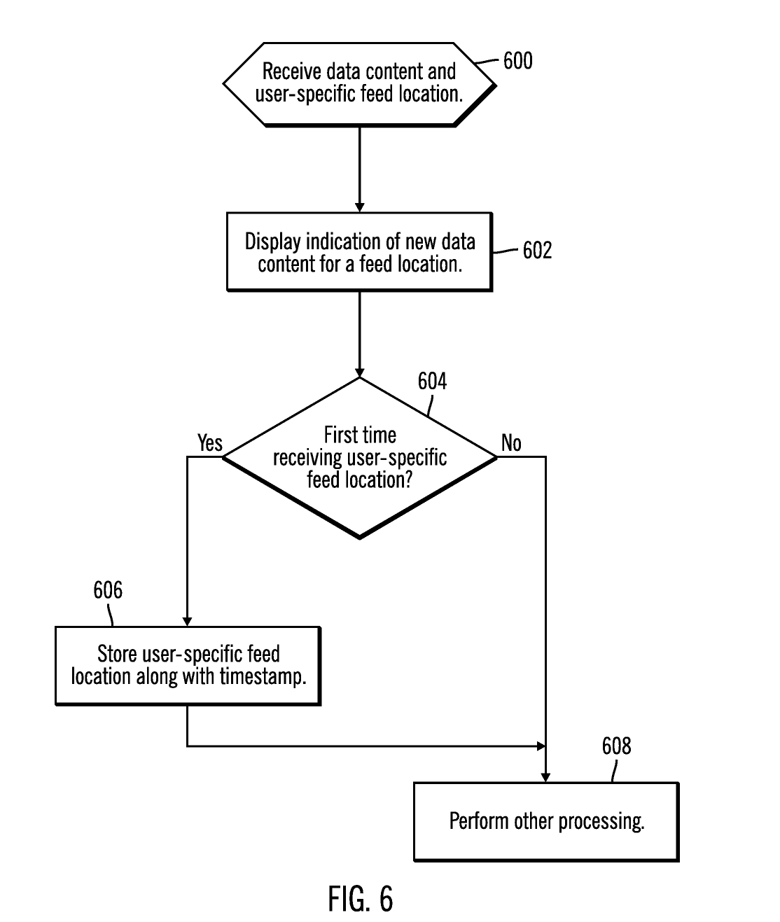

FIG. 6 illustrates logic performed by the RSS reader 212 in response to receiving data content 274 in accordance with certain embodiments. Control begins at block 600 with the RSS reader 212 receiving data content 274 and the user-specific feed location. In block 602, the RSS reader 212 displays an indication of new data content for a feed location. In block 604, the RSS reader 212 determines whether this it the first time this user-specific feed location has been received from the server computer 220. If so, processing continues to block 606, otherwise, processing continues to block 608. In block 606, the RSS reader 212 stores the user-specific feed location along with the timestamp and processing continues to block 608. In block 608, the RSS reader 212 performs other processing (e.g., accessing another RSS feed).

Thus, embodiments enable a browser 210 to identify itself to obtain customized RSS feeds. In certain embodiments, a computing device 200 may have more than one browser (e.g., Internet Explorer and Mozilla), and each browser may have a different identifier.

Embodiments are applicable to providing customized service/support information, as well as, providing any information a server computer 220 owner may want to transmit to a user (e.g., sales information, news, menus, etc.). With embodiments, users do not need to identify themselves to the server computer 220 and a cookie does not need to be stored on the computing device 200. Issuing the unique subscriber identifier with the feed location takes care of identifying the user.

In certain embodiments, once the user may be identified with the unique subscriber identifier for a customized RSS feed, the profile component 232 dynamically generates a custom profile 272. In certain embodiments, the custom profile 272 may be an RSS feed XML file customized for a specific user using a query on a content management system (CM). A content management system may be described as a system used to manage any type of stored content (e.g., Internet content, Word files, Portable Document Format (PDF) documents, or images with metadata used to classify the images, etc.). Then, a data content component 234 transforms the query output from the CM query and generates an XML file to be delivered to the user as an RSS feed. In certain embodiments, metadata attributes stored in the CM system, along with a tailored query, are used to create the customized XML file. Thus, embodiments are applicable in the case of a single server and also for a workload balanced set of servers, with each server having JSPs, ASPs or servlets running to generate the custom RSS feeds based on unique subscriber identifiers. Also each server would be able to generate an RSS feed XML file customized for a specific user, using a content management system with metadata attributes to create the customized XML file.

In certain embodiments, the customized RSS feed may be created via an Internet based dialog from the server computer 220 initiated at the time a user subscribes to an RSS feed or at a later time via a link embedded in the RSS feed. In such a case, the RSS file, when viewed on the browser, includes a link (with the unique subscriber identifier) at the top of the page that is labeled “update preferences”. When the user selects the link, the Internet site is accessed, and a settings page for preferences is presented in the browser from the server computer 220. Once saved, the server computer 220 updates the subscriber's profile file on the server computer 220.

While the RSS specifications and standards describe a channel sub-element “category” field, the category field may be described as a type of classification mechanism or a filter that is used for providing a classification of types of feeds that apply to a broad set of users. However, a category field lacks the personalization of embodiments, which apply to individual users and create customized RSS feeds specific for the individual users. In conventional systems, it would be up to the RSS reader 212 to choose to filter on this category field, and the filtering is not under the control of the server computer 220. In certain embodiments, the data content component 234 filters based on the category field associated with the user preferences. Thus, the category field may be a filter applied to the content that the server computer 220 serves back to the computing device 200.

In certain embodiments, an RSS reader plug-in is loaded by the user with a URL to an RSS feed. The RSS feed URL includes a unique subscriber identifier. The RSS URL may be, for example, a servlet, Java® Server Page (JSP), or Active Server Page (ASP). A servlet may be described as a small program that runs on an application server (e.g., a Java® application that runs within an application server environment). When the RSS reader plug-in checks an RSS feed for updates, the unique subscriber identifier is passed to an application server. This initiates a sequence where the servlet, JSP, or ASP runs a customized query against a CM database and uses the results to generate a customized RSS feed.

Thus, embodiments assign a unique subscriber identifier to a feed location when a user subscribes to an RSS feed and allow a user to use the unique subscriber identifier to obtain a customized RSS feed. Embodiments provide a filter at the server computer 220 based on the custom profiles 272 that describe user preferences to provide the customized RSS feed.

Although examples herein may have referred to RSS feeds, embodiments are applicable to Atom feeds and other feeds.

### ADDITIONAL EMBODIMENT DETAILS

The described operations may be implemented as a method, computer program product or apparatus using standard programming and/or engineering techniques to produce software, firmware, hardware, or any combination thereof.

Each of the embodiments may take the form of an entirely hardware embodiment, an entirely software embodiment or an embodiment containing both hardware and software elements. The embodiments may be implemented in software, which includes but is not limited to firmware, resident software, microcode, etc.

Furthermore, the embodiments may take the form of a computer program product accessible from a computer-usable or computer-readable medium providing program code for use by or in connection with a computer or any instruction execution system. For the purposes of this description, a computer-usable or computer readable medium may be any apparatus that may contain, store, communicate, propagate, or transport the program for use by or in connection with the instruction execution system, apparatus, or device.

The described operations may be implemented as code maintained in a computer-usable or computer readable medium, where a processor may read and execute the code from the computer readable medium. The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a rigid magnetic disk, an optical disk, magnetic storage medium (e.g., hard disk drives, floppy disks, tape, etc.), volatile and non-volatile memory devices (e.g., a random access memory (RAM), DRAMs, SRAMs, a read-only memory (ROM), PROMs, EEPROMs, Flash Memory, firmware, programmable logic, etc.). Current examples of optical disks include compact disk-read only memory (CD-ROM), compact disk-read/write (CD-R/W) and DVD.

The code implementing the described operations may further be implemented in hardware logic (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices.

A computer program product may comprise computer useable or computer readable media, hardware logic, and/or transmission signals in which code may be implemented. Of course, those skilled in the art will recognize that many modifications may be made to this configuration without departing from the scope of the embodiments, and that the computer program product may comprise any suitable information bearing medium known in the art.

The term logic may include, by way of example, software, hardware, firmware, and/or combinations of software and hardware.

Certain implementations may be directed to a method for deploying computing infrastructure by a person or automated processing integrating computer-readable code into a computing system, wherein the code in combination with the computing system is enabled to perform the operations of the described implementations.

The logic of FIGS. 3, 4, and 6 describes specific operations occurring in a particular order. In alternative embodiments, certain of the logic operations may be performed in a different order, modified or removed. Moreover, operations may be added to the above described logic and still conform to the described embodiments. Further, operations described herein may occur sequentially or certain operations may be processed in parallel, or operations described as performed by a single process may be performed by distributed processes.

The illustrated logic of FIGS. 3, 4, and 6 may be implemented in software, hardware, programmable and non-programmable gate array logic or in some combination of hardware, software, or gate array logic.

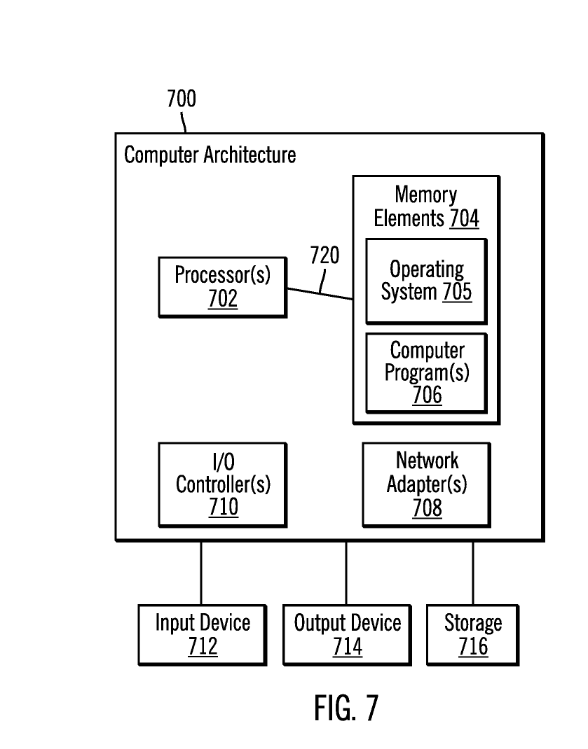

FIG. 7 illustrates a system architecture 700 that may be used in accordance with certain embodiments. Client computer 100 and/or server computer 120 may implement system architecture 700. The system architecture 700 is suitable for storing and/or executing program code and includes at least one processor 702 coupled directly or indirectly to memory elements 704 through a system bus 720. The memory elements 704 may include local memory employed during actual execution of the program code, bulk storage, and cache memories which provide temporary storage of at least some program code in order to reduce the number of times code must be retrieved from bulk storage during execution. The memory elements 704 include an operating system 705 and one or more computer programs 706.

Input/Output (I/O) devices 712, 714 (including but not limited to keyboards, displays, pointing devices, etc.) may be coupled to the system either directly or through intervening I/O controllers 710.

Network adapters 708 may also be coupled to the system to enable the data processing system to become coupled to other data processing systems or remote printers or storage devices through intervening private or public networks. Modems, cable modem and Ethernet cards are just a few of the currently available types of network adapters 708.

The system architecture 700 may be coupled to storage 716 (e.g., a non-volatile storage area, such as magnetic disk drives, optical disk drives, a tape drive, etc.). The storage 716 may comprise an internal storage device or an attached or network accessible storage. Computer programs 706 in storage 716 may be loaded into the memory elements 704 and executed by a processor 702 in a manner known in the art.

The system architecture 700 may include fewer components than illustrated, additional components not illustrated herein, or some combination of the components illustrated and additional components. The system architecture 700 may comprise any computing device known in the art, such as a mainframe, server, personal computer, workstation, laptop, handheld computer, telephony device, network appliance, virtualization device, storage controller, etc.

The foregoing description of embodiments of the invention has been presented for the purposes of illustration and description. It is not intended to be exhaustive or to limit the embodiments to the precise form disclosed. Many modifications and variations are possible in light of the above teaching. It is intended that the scope of the embodiments be limited not by this detailed description, but rather by the claims appended hereto. The above specification, examples and data provide a complete description of the manufacture and use of the composition of the embodiments. Since many embodiments may be made without departing from the spirit and scope of the embodiments, the embodiments reside in the claims hereinafter appended or any subsequently-filed claims, and their equivalents.

What is claimed is:

1. A computer-implemented method for accessing data, comprising:
in response to receiving a request for data content associated with a feed location,
determining whether the feed location has an associated unique subscriber identifier;
in response to determining that the feed location does not have an associated unique subscriber identifier, generating a unique subscriber identifier for the feed location, wherein the feed location and the unique subscriber identifier comprise a user-specific feed location;
associating user preferences with the user-specific feed location; and
filtering the data content based on the user preferences.

2. The method of claim 1, wherein the feed location comprises a location of a Really Simple Syndication (RSS) feed.

3. The method of claim 1, wherein the user preferences are obtained with a graphical user interface.

4. The method of claim 1, wherein the user preferences are obtained by tracking user activity.

5. The method of claim 1, wherein filtering the data content further comprises:
generating a custom query based on the user preferences; and
issuing the custom query against the data content.

6. The method of claim 5, further comprising:
receiving the data content in response to issuing the custom query; and
filtering the received data content based on a category field that provides a classification of types of feeds that apply to a broad set of users.

7. The method of claim 1, further comprising:
returning the filtered data content.

8. The method of claim 1, wherein a content management system provides information needed to generate a custom RSS feed XML file.

9. The method of claim 1, further comprising:
under control of a Really Simple Syndication (RSS) reader,
receiving a selection of the feed location from a user;
in response to determining that this is a first time the feed location is being selected by the user,
(i) storing the feed location and a timestamp; and
(ii) sending a request for the data content associated with the feed location to a server computer; and
in response to determining that this is not a first time the feed location is being selected by the user, sending the request for the data content associated with the feed location to a server computer along with the associated unique subscriber identifier.

10. The method of claim 1, further comprising:
under control of a Really Simple Syndication (RSS) reader, storing the user-specific feed location and a timestamp.

11. A computer program product comprising a computer useable medium including a computer readable program, wherein the computer readable program when executed on a computer causes the computer to:
in response to receiving a request for data content associated with a feed location,
determine whether the feed location has an associated unique subscriber identifier;
in response to determining that the feed location does not have an associated unique subscriber identifier, generate a unique subscriber identifier for the feed location, wherein the feed location and the unique subscriber identifier comprise a user-specific feed location;
associate user preferences with the user-specific feed location; and
filter the data content based on the user preferences.

12. The computer program product of claim 11, wherein the feed location comprises a location of a Really Simple Syndication (RSS) feed.

13. The computer program product of claim 11, wherein the user preferences are obtained with a graphical user interface.

14. The computer program product of claim 11, wherein the user preferences are obtained by tracking user activity

15. The computer program product of claim 11, wherein, when filtering the data content, the computer readable program when executed on a computer causes the computer to:
generate a custom query based on the user preferences; and
issue the custom query against the data content.

16. The computer program product of claim 15, wherein the computer readable program when executed on a computer causes the computer to:
receive the data content in response to issuing the custom query; and
filter the received data content based on a category field that provides a classification of types of feeds that apply to a broad set of users.

17. The computer program product of claim 11, wherein the computer readable program when executed on a computer causes the computer to:
return the filtered data content.

18. The computer program product of claim 11, wherein a content management system provides information needed to generate a custom RSS feed XML file.

19. The computer program product of claim 11, wherein the computer readable program when executed on a computer causes the computer to:
under control of a Really Simple Syndication (RSS) reader,
receive a selection of the feed location from a user;
in response to determining that this is a first time the feed location is being selected by the user,
(i) store the feed location and a timestamp; and
(ii) send a request for the data content associated with the feed location to a server computer; and
in response to determining that this is not a first time the feed location is being selected by the user, send the request for the data content associated with the feed location to a server computer along with the associated unique subscriber identifier.

20. The computer program product of claim 11, wherein the computer readable program when executed on a computer causes the computer to:
under control of a Really Simple Syndication (RSS) reader, store the user-specific feed location and a timestamp.

21. A system, comprising:
logic capable of performing operations, the operations comprising:
in response to receiving a request for data content associated with a feed location,
determining whether the feed location has an associated unique subscriber identifier;
in response to determining that the feed location does not have an associated unique subscriber identifier, generating a unique subscriber identifier for the feed location, wherein the feed location and the unique subscriber identifier comprise a user-specific feed location;
associating user preferences with the user-specific feed location; and
filtering the data content based on the user preferences.

22. The system of claim 21, wherein the feed location comprises a location of a Really Simple Syndication (RSS) feed.

23. The system of claim 21, wherein the user preferences are obtained with a graphical user interface.

24. The system of claim 21, wherein the user preferences are obtained by tracking user activity.

25. The system of claim 21, wherein the operations for filtering the data content further comprise:
generating a custom query based on the user preferences; and
issuing the custom query against the data content.

26. The system of claim 25, wherein the operations further comprise:
receiving the data content in response to issuing the custom query; and
filtering the received data content based on a category field that provides a classification of types of feeds that apply to a broad set of users.

27. The system of claim 21, wherein the operations further comprise:
returning the filtered data content.

28. The system of claim 21, wherein a content management system provides information needed to generate a custom RSS feed XML file.

29. The system of claim 21, wherein the operations further comprise:
under control of a Really Simple Syndication (RSS) reader,
receiving a selection of the feed location from a user;
in response to determining that this is a first time the feed location is being selected by the user,
(i) storing the feed location and a timestamp; and
(ii) sending a request for the data content associated with the feed location to a server computer; and
in response to determining that this is not a first time the feed location is being selected by the user, sending the request for the data content associated with the feed location to a server computer along with the associated unique subscriber identifier.

30. The system of claim 21, wherein the operations further comprise:
under control of a Really Simple Syndication (RSS) reader, storing the user-specific feed location and a timestamp.
